(19) United States
(12) Patent Application Publication
(10) Pub. No.: US 2019/0200574 A1
(43) Pub. Date: Jul. 4, 2019

(54) EDIBLE ANIMAL CHEW

(71) Applicant: Mars, Incorporated, McLean, VA (US)

(72) Inventors: Kaitlyn Keen, Franklin, TN (US); Vincent Joseph Falcone, Inverness, IL (US); Ralf Reiser, Buffalo, NY (US); Matthew Elliott, Batley (GB)

(73) Assignee: Mars, Incorporated, McLean, VA (US)

(21) Appl. No.: 16/332,807

(22) PCT Filed: Oct. 3, 2017
(86) PCT No.: PCT/US2017/054918

§ 371 Date: Mar. 13, 2019

Related U.S. Application Data
(60) Provisional application No. 62/403,703, filed on Oct. 3, 2016.

(51) Int. Cl. A01K 15/02

(52) U.S. Cl. CPC A01K 15/026

(57) ABSTRACT

Edible animal chews (100, 800, 900) are provided. The chews (100, 800, 900) are configured to fit within, and to contact front teeth, as well as teeth on both sides of, a dog's mouth. The chews (100, 800, 900) may be provided with self-positioning features, or may be provided with features for use by the animal's owner for positioning the chew (1000, 100, 1102, 1202, 1302, 1402, 1500, 1600, 200, 300, 400, 500, 600, 700, 800, 850, 900) within the animal's mouth. Methods of cleaning the teeth of an animal are also provided and comprise positioning the chew (1000, 100, 1102, 1202, 1302, 1402, 1500, 1600, 200, 300, 400, 500, 600, 700, 800, 850, 900) within the mouth of an animal, removing any reusable positioning feature, and allowing the animal to consume the chew (1000, 100, 1102, 1202, 1302, 1402, 1500, 1600, 200, 300, 400, 500, 600, 700, 800, 850, 900), wherein the consumption of the chew (1000, 100, 1102, 1202, 1302, 1402, 1500, 1600, 200, 300, 400, 500, 600, 700, 800, 850, 900) cleans the animal's teeth.

### BACKGROUND

Edible animal chews for cleaning of animal teeth are known, such as the Greenies® brand of dog dental chews. Many existing animal chews have an elongated geometry that is suitable to enable the animal (e.g., dog) to hold one end of the elongated geometry between their paws, while chewing on the other end. Such a geometry makes it easier for the animal to get a large number of bites on the chew, which are typically required to break down the chew, enabling the animal to consume it.

Although beloved by pets and thus effective at providing some measure of dental cleaning, positioning between the paws may not provide the optimal orientation to clean all of the teeth within a dog's mouth. Once the chew is provided to the dog, the owner has little control over which teeth in the animal's mouth contact the chew over the course of the bites. Coupled with the vast diversity in the shape and size of dogs mouths between breeds, there thus remains a need in the art for a chew that provides more thorough and efficient cleaning of more, if not all, of the teeth within the mouth of a dog.

### BRIEF DESCRIPTION

The present animal chew comprises a body that may comprise, consist essentially of, or consist of an edible chew composition. The body of the chew defines a base portion and spaced apart first and second arms extending therefrom. The longitudinal dimensions of the arms are oriented within a longitudinal plane of the body and extend at angles from the body within 30 degrees of each other. The base portion and arms define an elongated space extending from the base portion and between the first arm and the second arm.

The base portion, and first and second arms, are configured to fit within the mouth of a dog, and more particularly, to contact teeth on both sides and the front of the dogs mouth when positioned therein. The chew may be positioned by the owner, using any of the removable handles described herein, or, may be self-positioned via provision of one or more self-positioning feature as part of the chew.

### DRAWINGS

Understanding that the drawings depict only exemplary embodiments and are not therefore to be considered limiting in scope, the exemplary embodiments will be described with additional specificity and detail through the use of the accompanying drawings.

FIG. 1A is a perspective view of an example edible animal chew having a geometry configured to contact teeth on both the left and right sides, as well as the front, of an animal's mouth during a bite.

FIG. 1B is a perspective view of the chew of 1A, comprising a stem for attachment of an edible or non-edible handle.

FIG. 2 is a perspective view of another example edible animal chew having a geometry configured to contact teeth on both the left and right sides, as well as the front, of an animal's mouth during a bite.

FIG. 3 is a perspective view of yet another example edible animal chew having a geometry configured to contact teeth on both the left and right sides, as well as the front, of an animal's mouth during a bite.

FIG. 4A is a perspective view of still another example edible animal chew having a geometry configured to contact teeth on both the left and right sides, as well as the front, of an animal's mouth during a bite.

FIG. 4B is a perspective view of the chew of 4A, comprising a stem for attachment of an edible or non-edible handle.

FIG. 5A is a perspective view of yet another example edible animal chew having a geometry configured to contact teeth on both the left and right sides, as well as the front, of an animal's mouth during a bite.

FIG. 5B is a perspective view of an edible animal chew similar to that shown in FIG. 5A, without a crosspiece 502 between arms 104, 106.

FIG. 6 is a perspective view of an example edible animal chew including multiple textures.

FIG. 7 is a perspective view of still another example edible animal chew having a geometry configured to contact teeth on both the left and right sides, as well as the front, of an animal's mouth during a bite.

FIG. 8A is a perspective view of an example edible animal chew having a domed surface in a central portion thereof and configured to contact teeth on the left and right sides, as well as the front, of an animal's mouth during a bite.

FIG. 8B is a perspective view of another example edible animal chew having a domed surface in a central portion thereof and configured to contact teeth on the left and right sides, as well as the front, of an animal's mouth during a bite.

FIG. 8C is a perspective view of another example edible animal chew having a domed surface in a central portion thereof and configured to contact teeth on the left and right sides, as well as the front, of an animal's mouth during a bite.

FIG. 9A is a perspective view of still another example edible animal chew having a geometry configured to contact teeth on both the left and right sides, as well as the front, of an animal's mouth during a bite, comprising bristles 904 on the distal ends of arms 104, 106.

FIG. 9B is a perspective view of still another example edible animal chew similar to the chew shown in FIG. 9A, comprising bristles 904 on the distal ends of arms 104, 106 and nubs arranged within base portion 102.

FIG. 9C is a perspective view of still another example edible animal chew similar to the chew shown in FIG. 9A, comprising bristles 904 on the distal ends of arms 104, 106 and recessed bristles 902 within base portion 102 and the portions of arms 104, 106 proximate thereto.

FIG. 10 is a perspective view of an example edible animal chew including an edible handle.

FIG. 11 is an exploded perspective view of an example animal chew providing system including a non-edible handle and an edible animal chew configured to connect to the handle.

FIG. 12 is an exploded perspective view of another example animal chew providing system including a non-edible handle and an edible animal chew configured to connect to the handle.

FIG. 13 is an exploded perspective view of yet another example animal chew providing system including a non-edible handle and an edible animal chew configured to connect to the handle.

FIG. 14 is an exploded perspective view of still another example animal chew providing system including a non-edible handle and an edible animal chew configured to connect to the handle.

FIG. 15A is a perspective view of an example edible animal chew having a geometry configured to contact teeth on both the left and right sides, as well as the front, of an animal's mouth during a bite.

FIG. 15B is a perspective view of a chew similar to that shown in FIG. 15A, wherein the distal ends of arms 104, 106 are rotated about a longitudinal axis thereof.

FIG. 16A is a perspective view of an example edible animal chew having a geometry configured to contact teeth on both the left and right sides, as well as the front, of an animal's mouth during a bite.

FIG. 16B is a perspective view of the chew of 16A, comprising a stem for attachment of an edible or non-edible handle.

### DETAILED DESCRIPTION

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

Reference throughout the specification to “one example” or “an example” means that a particular feature, structure, or characteristic described in connection with an example is included in at least one embodiment. Thus, the appearance of the phrases “in one example” or “in an example” in various places throughout the specification is not necessarily referring to the same embodiment. Further, the particular features, structures or characteristics may be combined in any suitable manner in one or more embodiments.

All references to singular characteristics or limitations of the present disclosure shall include the corresponding plural characteristic(s) or limitation(s) and vice versa, unless otherwise specified or clearly implied to the contrary by the context in which the reference is made.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a vitamin” may include a plurality of such vitamins, and so forth.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “animal” or “pet” means a domesticated dog or other domesticated, omnivorous canid of like nutritional needs to a domesticated dog. “Dog” includes adults, between 1 year of age and 7 years of age; seniors, older than 7 years of age; and super-seniors, older than 11 years of age. For the purpose of this disclosure, “dog” does not include puppies under the age of 1 year.

A pet food or chew expressly excludes items which are capable of being orally ingested but are not intended to be ingested, such as rocks.

As used herein, “dietary composition” refers to any composition utilized as part of the diet for a dog. This includes, but is not limited to, pet food, treat, chew, biscuit, gravy, supplement, topper, and combinations thereof.

As used herein, “nutritionally balanced” and/or “nutritionally complete” refers to a composition capable of sustaining life as the sole dietary ration for an animal, without the need for any other substance, except possibly water.

All lists of items, such as, for example, lists of ingredients, are intended to and should be interpreted as Markush groups. Thus, all lists can be read and interpreted as items “selected from the group consisting of” . . . list of items . . . “and combinations and mixtures thereof.”

All percentages in the present disclosure are listed as percent by weight on the total weight of the material or mixture, unless explicitly noted otherwise.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

Although some existing animal chews have a geometry that encourages a large number of bites on the chew, there is little control over which teeth in the animal's mouth contact the chew over the course of the bites. Consequently, there is little control over which teeth are cleaned by the chew. Embodiments described herein address this problem by providing animal chews comprising positioning features to provide control over which teeth contact the chew during a bite and/or to maximize contact by allowing for contact with more teeth and/or greater surface area of the teeth than other chews. In many embodiments, the animal chew has a wide geometry that is configured to contact teeth on both the left and right sides, as well as the front of the mouth and/or the front teeth during each bite on the chew. In any case, by enabling control over which teeth contact the chew during a bite, the animal chews herein can increase the likelihood that more teeth will be effectively cleaned with a single chew.

Advantageously, the chews described herein can be used to optimize caloric intake of an animal and optimize the effectiveness of teeth cleaning by matching the geometry of the chew to the geometry of the mouth. Excessive calories and over-feeding are a significant issue with the petcare industry as owners are known to over-indulge their animals. A convention that is increasingly advocated within the petcare industry is that following the feeding guide for a complementary product should contribute no more than 10% of the daily calories for the animal. An issue for any petcare company is to tune the size of individual portions to the size of the dog and to balance this with the commercial needs of simplification of product ranges and formats. As a result of the simplification of product ranges it is usual practice to define weight ranges across the broad spectrum of dog sizes and create a product suitable for the average dog in the range or to one of the extremes. The clear consequence of such an approach is that a product designed for the centre-point of a weight range will over-feed an animal at the bottom of the weight range and risk an increase in body weight as a result. Equally a product that relies on a texture and lasting time combination for product effectiveness would be less effective for dogs to the top end of any range if the product targets the centre point. Traditional product design and manufacturing would be unable to over-come this issue in any practical sense.

The product and manufacturing techniques described herein enable a new approach to calorie control and feeding regimen that would reduce the risk of over-feeding while maintaining optimum product effect for the animal in question. The mouth-mimicking geometry of the chews described herein enable a targeted size and weight for much smaller cross-sections of the dog population, even approaching the level of individual breed of dog and potentially the individual dog themselves. For example, a treat could be targeted to meet the needs of a dog under 20 lbs in weight, but the need for efficacy requires the product to meet the needs of a 20 lb dog, a Jack Russell terrier for example. With the tailored design of the chews described herein it is possible to design a product to match not only the size of the target animal, but also the geometric form of the animal's mouth and teeth such that chewing and teeth cleaning efficiency is maximised via only the consumption of the chew, rather than requiring owner manipulation of the chew beyond initial positions. Therefore the volume of material and calorie impact can be reduced and optimised.

Further to this, dog size can be further segmented into skull form. Within dogs there are three predominant skull forms into which breeds can be categorised. Brachycephalic, a short muzzle breed in which the teeth and mouth are compact with a relatively broad width to length ratio. Examples of this breed would be pugs or bulldogs or boxers. Mesaticephalic breeds have an intermediate muzzle dimension and compromise some of the more commonly known breeds such as Labradors and German shepherd dogs. Dolichocephalic breeds have elongated muzzles relative to the width of the jaw, for example borzois. A key point is that within a weight range there are multiple breeds that can represent significantly different oral cavities. For example, a British bulldog at typically 50 lbs in weight would overlap in the same region as a Labrador retriever at up to 60 lbs in weight. The bulldog is a brachycephalic breed with short muzzle and the Labrador is mesaticephalic. Although the calorie requirement of the two animals may not be significantly different using the arbitrary weight ranges, the geometry of the oral cavity is radically different between the breeds and therefore the exact requirements for an effective chew for the two breeds also differs radically. A small breed comparison, a Pug (brachycephalic) versus a Chihuahua (mesaticephalic) would require a similar optimisation of geometry and size in order to perfectly meet the needs of the animal. The ability to segment and provide chews tailored to the mouth geometries across a matrix of dog size and breed shape to optimise effectiveness and caloric loading is a significant step change for complementary petcare products.

The animal chews described herein are edible, either in whole or in part. Desirably, the body of chew is edible, while any positioning assemblies may be edible, or inedible and thus, reusable. The term “edible” means that the animal chew is configured to be consumed by the animal. An edible material is not harmful to an animal when consumed and contributes to the nutritional and calorific content of the animal's diet. In a preferred example, an edible animal chew is suitable for contributing from about 5% to about 15%, and preferably from about 10% to about 15%, of the recommended calorific intake of the animal. In some embodiments, the animal chew is delivered daily and is suitable for contributing from about 5% to about 15%, and preferably from about 10% to about 15%, of the recommended daily calorific intake of the animal.

The term “edible” is also meant to indicate that the majority of the chew is digestible by the animal. The term “digestible” in turn, is meant to indicate material that is capable of being broken down and utilized by the animal in the form of calories or nutrients. The chews of the present invention may contain amounts of soluble or insoluble fiber, the latter not being digestible as that term is used herein, and so in such embodiments, less than the entirety of the chew may be digestible. Generally speaking, all other components of the chew will be digestible, and the chew will not comprise indigestible components other than insoluble fiber.

Additionally, the animal chews described herein have an animal chew composition, which distinguishes the animal chew as a ‘chew’ as opposed to a ‘food’. An “animal chew composition” refers to an edible material that can be distinguished from an animal food in that an animal chew composition is typically not nutritionally complete and balanced and is not intended to form a large, i.e., greater than 20%, portion of the daily caloric intake of a dog. Also, the consumption time for a chew is normally much longer than the consumption time for a piece of food. A piece of food may generally be consumed in less than 30 seconds by an average sized dog, wherein a chew would take at least 90 seconds for an average-sized dog to consume. More particularly, many chews would take at least 200 seconds, at least 300 seconds, or longer than 300 seconds for an average-sized dog to consume. An average size dog may typically take between 90 and 300 seconds to consume a chew.

An animal food has a composition that breaks down in response to a single or low number (e.g., less than or equal to three) bites. In contrast, an animal chew composition is configured to break down gradually over the course of many (e.g., greater than ten) bites, and/or to break down only after the large number (again, e.g., greater than ten) of bites. However, since the chew is configured to be consumed, the animal chew composition is configured to eventually break down within a number of bites such that the animal is likely to consume the entire chew in a single sitting.

The calorific and nutritional contribution to the animal's diet is also a differentiating feature between a ‘chew’ and a ‘food’. Specifically, a conventional animal ‘food’ is nutritionally complete and provides the full range of the animal's daily nutrition requirements. It is also intended to be the major source, i.e., greater than 50%, or greater than 60%, or greater than 70%, or greater than 80%, of the animal's calorific intake. In contrast, the edible animal chews described herein are not an independent source of the animal's complete daily nutritional and calorific needs, and hence can be referred to as “nutritionally incomplete”.

Additionally, an animal chew composition typically allows an animal's tooth to penetrate into the material during a bite, and it has an elastic response, such that an indentation formed by the tooth may reshape to approximate the original shape of the chew, once the animal's tooth is withdrawn. Thus, the tooth is allowed to spread the material apart, and the material contacts the sides of the tooth as it is doing so. This contact provides a mechanical cleaning action via abrasion as the tooth is inserted into and removed from the material.

Examples of materials suitable for use as an animal chew composition are described in International Patent Application Publication No. WO 2014/066438, titled “Aerated Injection Molded Pet Chew”, assigned to Mars, Incorporated, and International Patent Application Publication No. WO 2014/155113, titled “Edible Animal Chew”, also assigned to Mars, Incorporated. Both WO 2014/066438 and WO 2014/155113 are hereby incorporated herein by reference in their entirety, for any and all purposes.

The present animal chew comprises a body that may comprise, consist essentially of, or consist of an edible chew composition. The body of the chew defines a base portion and spaced apart first and second arms extending therefrom. The longitudinal dimensions of the arms are oriented within a longitudinal plane of the body and extend at angles from the body within 30 degrees of each other. The base portion and arms define an elongated space extending from the base portion and between the first arm and the second arm.

The base portion, and first and second arms, are configured to fit within the mouth of a dog, and more particularly, to contact teeth on both sides and the front of the dogs mouth when positioned therein. The chew may be positioned by the owner, using any of the edible or removable and reusable handles or projections described herein, or, may be self-positioned via provision of one or more self-positioning features as part of the chew. The base portion and first and second arms desirably comprise one or more features configured to contact and clean teeth while the dog consumes the chew. Because the chew is edible, and the chewing motion of the dog provides the manipulation of the positioned chew against the teeth, manipulation of the chew by the owner is not required after provision and potentially initial positioning.

The present chews are advantageously configured to fit within a dog's mouth, and to contact the front teeth, as well as the teeth on both sides of the dog's mouth when positioned therein. As such, the chews are generally U-shaped. Additionally, the chews may be provided various shapes and sizes so as to be useful in dogs of all breeds, jaw types and sizes. The arms of the chew may flare outwardly toward the distal ends thereof.

The present chews may be provided with self-positioning features. As used herein, the phrase “self-positioning features” mean features that, when engaged within the mouth of the dog, either via tooth placement, tongue placement, or placement against the roof of the mouth, operate to orient the chew within the dogs mouth so that teeth on both sides and the front of the dogs mouth are contacted by the chew. Self-positioning features can include, e.g., operatively placed flanges, indentations, projections, spheres, hemispheres or domes or crosspieces.

In some embodiments, the first and/or second arms are provided with indentations configured to accept the canine teeth of the animal consuming the chew. These indentations can be shaped and sized so that the sides of the indentation contact the surfaces of the canine teeth when inserted there through, thereby cleaning the canine teeth. These indentations can further act as self-positioning features as placement or insertion of the canine teeth therein can result in contact of the base portion with the front teeth, and contact of the arms with teeth on both sides of the dog's mouth. These indentations may be provided on both the upper and lower surfaces of the arms. If provided on both surfaces, they may comprise a thin layer of material between the opposing indentations that will provide further cleaning benefit when chewed through, or, the indentations may be through holes extending from one side of the arms to the other.

The base portion and arms may comprise upper and/or lower edge flanges, extending along an outer edge of the base portion, the first arm, and the second arm, in a direction normal to the longitudinal plane. Such flanges, when provided, assist in the positioning of the chew within the mouth, and against the teeth of the dog and may also be provided with lateral surface features on the tooth facing surfaces thereof to provide additional cleaning action when the chew is consumed by a dog.

The chews may include a crosspiece, extending across the elongated space between the first and second arms. Such a crosspiece may assist in positioning, and re-positioning, of the chew within the dogs mouth.

Similarly, the first and second arms may further include one or more transverse flanges on the upper and/or lower surfaces thereof, spaced apart to accommodate the placement of teeth there between, and projecting in a direction normal to the longitudinal plane. As with the edge flanges, such transverse flanges may assist in the positioning and retention of the chew within the dog's mouth during consumption, but may also provide additional cleaning action to the various surfaces of the teeth they contact when the chew is consumed by a dog.

A dome, hemisphere or sphere may be provided in between the first and second arms, and in such embodiments, may assist in the self-positioning of the chew within the animal's mouth. The dome, hemisphere or sphere may be provided such that the circumference thereof abuts the inner edges of the base portion, and at least a portion of the inner edges of the first and second arms. Or, the dome hemisphere or sphere may be of a smaller size and bear a flange about the circumference thereof within a longitudinal plane of the chew that extends to, and adjoins with, the inner edges of the base portion and first and second arms.

In addition to, or instead of, any or all of the self-positioning features described herein, the chew may further include a positioning feature configured to be used by an owner to position the chew within their dog's mouth. Such positioning features can include projections, or reusable and removable or edible integral handles. If handles are included, they may be integral with the chew and also formed of edible material, or, may be separable. If separable, they may be inedible and reusable, or, may be consumable.

If the chew is to be provided with a separable handle, the chew may desirably include a feature configured to engage with the handle. For example, the base portion of the chew may be provided with a stem including features, such as tabs or projections, adapted to reversibly engage with a handle.

The base portion may include projections from either or both sides thereof. Such projections, extending in the longitudinal plane, outward from the base portion proximate the base line and in a direction approximately parallel with the base line, may be used by an owner to position the chew within a dog's mouth.

The first arm and the second arm have a longitudinal dimension in the range of 0.5 to 6 inches, as measured from a base line within base portion tangential to the elongated space. The elongated space may have a transverse dimension of from 0.25 to 3 inches at one point between the arms and parallel to the base line. The first and/or second arms may be symmetric about a longitudinal plane of the chew, or may be asymmetric. Desirably, the first and second arms are symmetric to each other.

The chews described herein are desirably comprised entirely of an edible animal chew composition. The chews may be comprised entirely of the same composition, or, multiple edible animal chew compositions may be used. Furthermore, and whether one or multiple edible animal chew compositions are used, the chew may be formed in layers with each layer having a different structure. For example, in some embodiments, outer layers may be made from the same edible animal chew composition and may be substantially solid, and an inner layer may be provided of the same, or a different, material having a lattice or aerated structure.

In some embodiments, sockets may be provided in the upper and/or lower surfaces of the base portion or first and second arms. In such embodiments, treats or food items may be inserted into the sockets to further incent the dog to consume the chew. Chews or treats may also be inserted in between transverse flanges of the arms, in embodiments including transverse flanges.

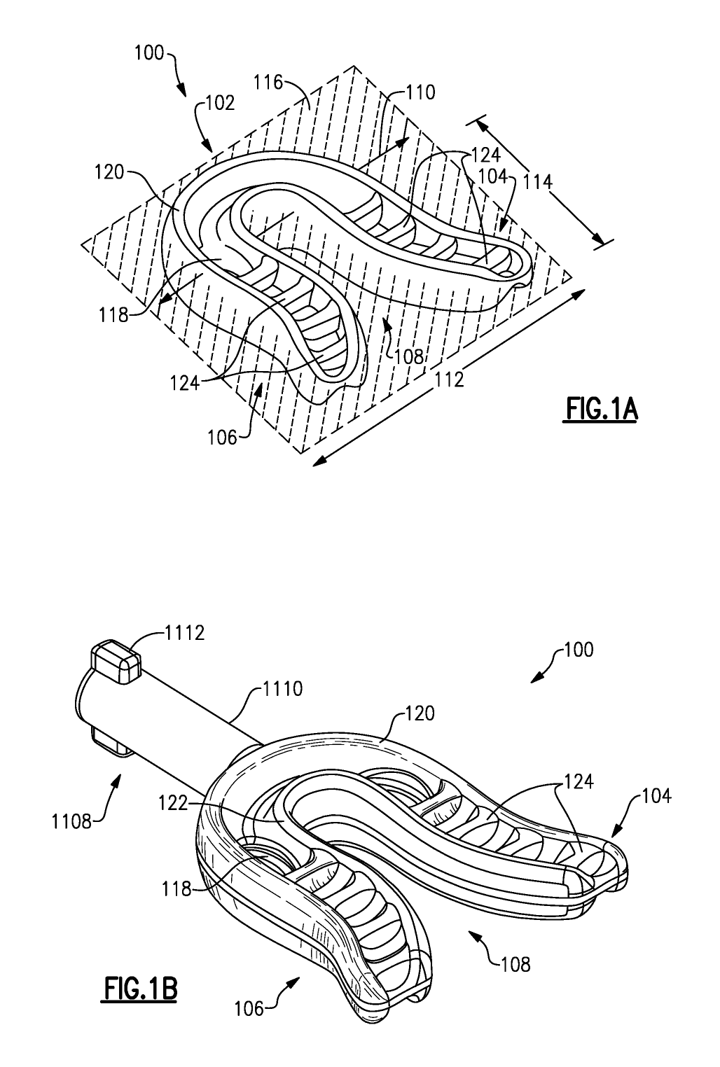

FIGS. 1A and 1B show an example of an edible animal chew 100 having a geometry that provides increased control over the particular teeth, or number of teeth in an animal's mouth that contact the chew 100. The chew 100 provides increased control by having a geometry that corresponds to the geometry of an animal's mouth. This chew geometry enables many of the teeth of an animal, such as the front and side teeth, to contact the chew during consumption. Thus, there is an increased likelihood that chew 100 will contact and clean more teeth in an animal's mouth while being consumed as compared to conventional edible chews.

The edible animal chew 100 has a body having an animal chew composition. The body defines a base portion 102 and a first arm 104 and a second arm 106, each extending from the base portion 102. The second arm 106 is spaced apart from the first arm 104 defining an elongated space 108 between the two arms 104,106. In general, the chew 100 has a U-shaped geometry that corresponds to the shape of an animal (e.g., dog) jaw. This geometry enables the chew 100 to contact many, if not all, of the teeth of the animal during consumption. In this way, the chew 100 can provide improved tooth cleaning ability.

As an animal mouth exhibits symmetry about the animal's midsagittal plane, the chew 100 can also be correspondingly symmetric about a plane running in between and approximately parallel with the first and second arms 104, 106. Additionally, the chew 100 can be symmetric about a longitudinal plane 116 which corresponds to the rough plane formed by the contact surfaces of the teeth in an animal's mouth. Thus, the chew 100 can be symmetric about two planes, the longitudinal plane 116 and a plane extending perpendicular to the longitudinal plane, between the first and second arms 104, 106.

The first and second arms 104, 106 have elongated geometries to correspond to the left and right rows of teeth in the jaw of an animal. The longitudinal dimensions 114 of the first and second arms 104, 106 are oriented in the longitudinal plane 116 to correspond to the plane of the bite of an animal mouth. Moreover, the longitudinal dimensions 114 of the first and second arms 104, 106 are oriented within 30 degrees of one another, again to correspond to the angle between the left and right rows of teeth of an animal jaw.

In an example, the longitudinal dimension 114 of the first and second arms 104, 106 is, in some embodiments, 0.5 to 5.75 inches. The longitudinal dimension 114 is defined from a base line 110 of the chew 100. The base line 110 extends within the base portion 102, tangent to the elongated space 108, within the longitudinal plane 116. The longitudinal dimension 114 of the first and second arms 104, 106 is defined from this base line 110 to the distal ends thereof. The distal ends of the first and second arms 104, 106 can be defined by a distal line 112 that extends parallel with the base line 110 tangent to the distal ends of both arms 104, 106. Typically, both arms 104, 106 will have the same longitudinal dimensions 114. To correspond with an animal, especially a dog's mouth, the distal ends of the arms 104, 106 can flare apart from one another. For example, if the arms extend at an angle less than 30 degrees from perpendicular from the base portion, a flare at the distal end may increase this angle by from 1 to 10, or 1 to 5 degrees. An overall length (dimension of the chew perpendicular to base line 110 within the longitudinal plane 116) of the chew 100 is in the range of 1 to 6 inches.

The elongated space 108 defined between the arms 104, 106 of the chew 100 provides space for the tongue of an animal and reduces the amount of material in the chew 100. Reducing the amount of material in the chew 100 may be desired in order to maintain a lower caloric intake of the chew 100 when consumed by an animal. Since the arms 104, 106 have a geometry that corresponds with the jaw of an animal, the arms 104, 106 can, in certain embodiments, have a generally constant and/or constant width, the width defined in the longitudinal plane 116, parallel to the base line 110. Additionally, the elongated space 108 can have a transverse dimension (parallel to the base line 110 within the longitudinal plane 116) that is in the range of 0.25 to 3 inches at least one location. In an example, the transverse dimension of the elongated space increases proximate the distal ends of the arms 104, 106 due to the flare in the arms 104, 106. An overall width (dimension of the chew parallel to base line 110 within the longitudinal plane 116) of the chew 100 is in the range of 0.5 to 3.5 inches. The base portion 102 can have a width (perpendicular to the base line 110 within the longitudinal plane 116) that is similar to the width of the arms 104, 106. In the example shown in FIGS. 1A and 1B, the base portion 102 and the arms 104, 106 together form a smooth U-shape having a generally consistent width.

The chew 100 can define an indentation 118 in each arm 104, 106. The indentations 118 recess inward from a surface (top) that is parallel with the longitudinal plane 116. The indentations 118 recess inward from the surface of the chew in this area, in a direction normal to the longitudinal plane 116. The indentations 118 are disposed proximate the respective intersections of the arms 104, 106 and the base portion 102. This location at the “corner” of the U/jaw shape corresponds to the location of the canine teeth. As such, the indentations 118 provide space for the canine teeth during a bite on the chew 100. Providing this space for the canine teeth enables the animal to bite down farther onto the chew 100 and increases contact between the chew 100 and the remaining teeth. Accordingly, the cross-sectional dimensions (in a plane parallel with the longitudinal plane 116) of the indentations 118 can correspond to the cross-sectional dimensions of the canine teeth. In an example, the indentations 118 can extend entirely through the chew 100 such that they form an aperture in the chew 100. In another example, matching indentations can be defined in the reverse side (bottom) of the chew 100, and a thin layer of the animal chew composition can extend across, demarcating the indentation 118 on one surface (top) from the indentation on the reverse surface. This thin layer of animal chew composition can be less than 0.25 inches thick, and in a particular example less than 0.1 inches thick.

To increase contact between the sides of the teeth and the chew 100, the chew 100 can define one or more flanges projecting vertically (normal to the longitudinal plane 116) from the top and/or bottom surfaces of the base portion 102 and/or arms 104, 106. In the example shown in FIG. 1, an upper outer flange 120 projects vertically from the outer edge of the top surface of the base portion 102 and the arms 104, 106. This upper outer flange 120 is configured to contact the outer surfaces of the upper teeth during a bite. A corresponding lower outer flange (not shown) can project downward from the outer edge of the bottom surface of the base portion 102 and arms 104, 106, superposed with the upper outer flange 120 to contact the outer surfaces of the lower teeth. Similarly, an upper inner flange 122 can project vertically from the inner edge of the top surface of the base portion 102 and the arms 104, 106. This upper inner flange 122 is configured to contact the inner surfaces of the upper teeth. A lower inner flange (not shown) can project downward from the inner edge of the lower surface, superposed with the upper inner flange 122 to contact the inner surfaces of the lower teeth.

In other examples, any single flange or any combination of the flanges (e.g., any upper, lower, inner, or outer, as well as any flange on the base portion 102, first arm 104, or second arm 106) described above can included on a chew 100. Although the description above contemplates a symmetrical chew, or wherein at least some features or flanges are symmetrical about the longitudinal plane, this does not have to be the case, and in one specific alternative embodiment, the chew is not symmetrical about the longitudinal plane. In such embodiments, repositioning of the chew, as is contemplated during consumption, may result in the application of the features or flanges alternately between the top and bottom teeth, i.e., the dog may position the chew during consumption so that for a period of time, the flanges contact upper teeth, and then may reposition the chew so that the flanges contact the lower teeth. Such chews may be advantageous in that they may be easier for the dog to consume, by not requiring a fit around both the upper and lower teeth, may be more comfortable within the dogs mouth and/or may be easier to manufacture.

Additionally, the flanges can be continuous through and from the first arm 104, base portion 102, and second arm 106, or can have one or more discontinuities as they extend along the chew 100.

In an example the height (normal to the longitudinal plane 116) of the chew 100 is greater in the base portion 102 and reduces towards the distal ends of the arms 104, 106. Or, the opposite can be true and the height of the chew 100 can be smaller in the base portion and increase towards the distal ends of the arms 104, 106. In an example, the height from the top edges of the upper outer/inner flanges 120, 122 to the bottom edges of the lower outer/inner flanges is in the range of 0.25 to 2 inches.

Chew 100 can also include one or more upper transverse flanges 124 on any one or more of the base portion 102 and arms 104, 106. The upper transverse flanges 124 project vertically from the top surface of the chew 100 and extend transversely across the arms 104, 106 and/or base portion 102. The example shown in FIG. 1 includes upper transverse flanges on the arms 104, 106, but none on the base portion 102. The upper transverse flanges 124 can extend across most or all of the width of the base portion 102 and/or arms 104, 106. In examples where the chew 100 includes inner and/or outer flanges 120, 122, upper transverse flanges can extend from outer flanges 120 to inner flanges 122. One or more lower transverse flanges can also be included on the lower surface of the chew 100, superposed with the upper transverse flanges 124. The upper/lower transverse flanges can provide increased contact with the sides of the teeth in between adjacent teeth.

In the example shown in FIGS. 1A and 1B, the surfaces in between the flanges 120, 122 and 124 of the chew 100 are generally flat. In an example, the thickness of the chew 100 (e.g., the distance between the top and bottom surfaces) can decrease slightly from the base portion 102 toward the distal end of the arms 104, 106.

FIG. 1B also shows stem 1108, including main body 1110 and tabs 1112. Stem 1108, as well as its connection to a handle (not shown in FIGS. 1A and 1B), is discussed further below in connection with FIG. 12.

FIG. 2 is another example of a chew 200 having a geometry that corresponds to the geometry of an animal's mouth Chew 200 is similar in many respects to chew 100, however chew 200 includes left and right wing projections 202 extending from the base portion 102. The left and right wing projections 202 extend from the base portion 102 in the longitudinal plane 116 and proximate the base line 110. As such, the left and right wing projections 202 extend outward proximate the “corners” of the U-shaped geometry. The left wing projection 202 extends in the opposite direction of the right wing projection, both in a direction approximately parallel with the base line 110. Chew 200 does not include the canine indentations 118, present in chew 100 and the left and right wing projection can be used by an owner to position chew 200 within the mouth of the animal.

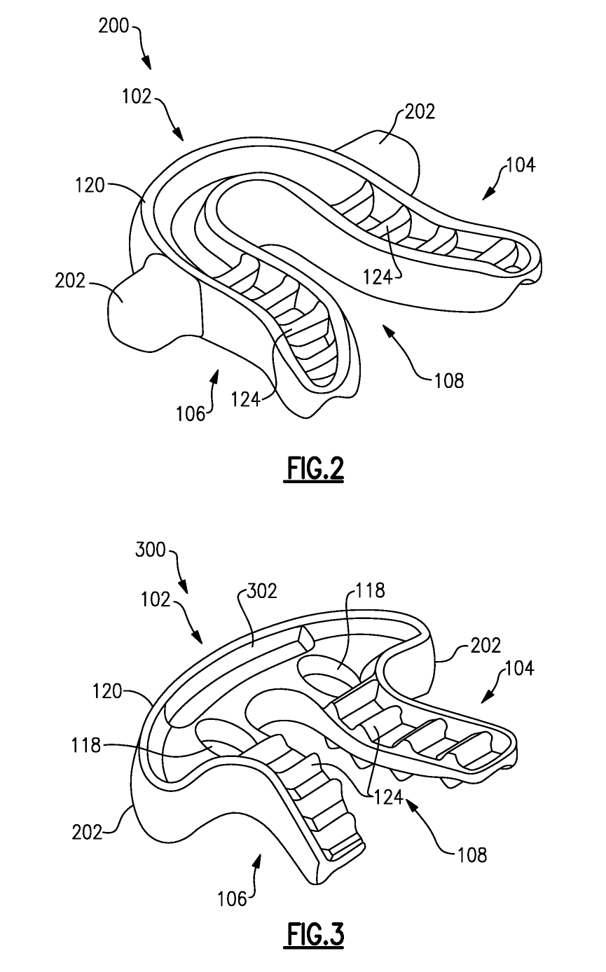

FIG. 3 is yet another example of a chew 300 having a geometry corresponding to the mouth of an animal. Chew 300 includes left and right wing projections 202, which have a different geometry than the wing projections of chew 200. In contrast to chews 100 and 200, chew 300 does not include upper or lower inner flanges 122. Similar to chew 100, chew 300 includes canine indentations 118. Chew 300 illustrates an example of a thin layer of animal chew material demarcating the upper canine indentations 118 from their superposed lower canine indentations. Chew 300 also includes an upper incisor indentation 302 recessed into the top surface of the base portion. A lower incisor indentation (not shown) recessed into the bottom surface, supposed with the upper incisor indentation 302 can also be included. The upper and lower incisor indentations provide space for the incisors to extend into during a bite. Projections 202 can be used by an owner to position chew 300 within the mouth of a dog, whereas canine and incisor indentations 118 and 302 can assist the chew 300 to self-position within the dog's mouth.

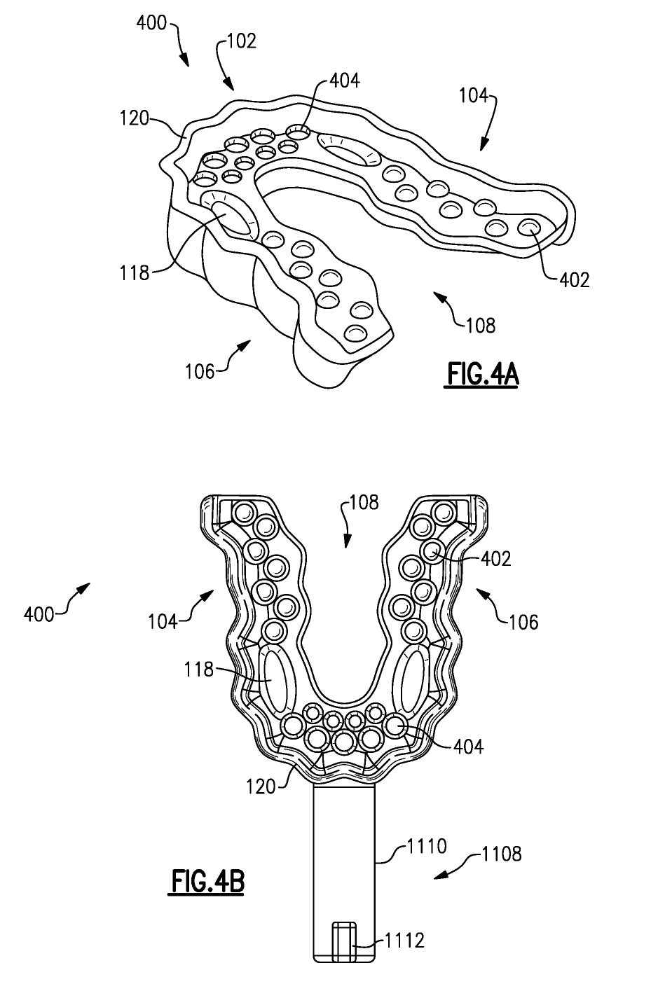

FIGS. 4A and 4B show another example of a chew 400 having a geometry corresponding to the mouth of an animal. Chew 400 is similar to the above described chews, except chew 400 includes a plurality of protrusions 402 and smaller indentations 404 on the top and bottom horizontal surfaces to aid in contacting the varied surfaces of an animal's teeth. Additionally, the upper outer flanges 120 extend along the chew 400 along a jagged line, as compared to the smooth linear shape of the outer flanges 120 shown in chew 100 in FIG. 1. The arrangement of protrusions 402, indentations 404 and flanges 120 may render chew 400 suitable for a range of sizes of animal mouths and/or may enable chew 400 to accommodate alternate chewing positions or patterns. Although described as being symmetrical about longitudinal axis 116 (not shown in FIGS. 4A and 4B), chew 400 may also be asymmetrical about longitudinal axis 116, with protrusions 402 and indentations 404 being provided on only one surface of chew 400. In such embodiments, protrusions 402, indentations 404 and outer flanges may be provided on the same, or different surfaces of chew 400.

As shown in FIG. 4B, chew 400 can also include stem 1108, including main body 1110 and tabs 1112. Stem 1108, as well as its connection to a handle (not shown in FIGS. 4A and 4B), is discussed further below in connection with FIG. 12.

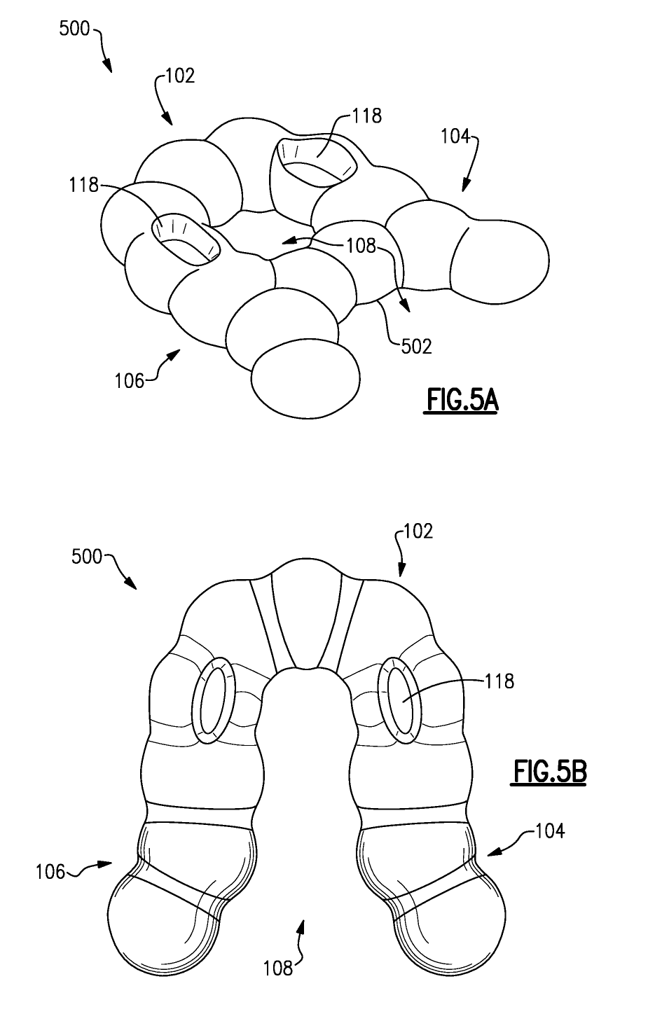

FIGS. 5A and 5B show an example of a chew 500 having a geometry corresponding to the mouth of an animal. Chew 500 has a geometry resembling a plurality of interconnected bubbles or spheres. Chew 500 as shown in FIG. 5A also includes a crosspiece 502 extending in the longitudinal plane 116, from the first arm 104 to the second arm 106, dividing the elongated space 108. As can be seen, although chew 500 includes indentations 118, chew 500 does not include any of flanges 120, 122 or 124. Orientation of chew 500 within the mouth of a dog can be assisted by indentations 118, and repositioning of the chew during consumption may be assisted by crosspiece 502. FIG. 5B is a top view of a chew 500, including canine indentations 118, but not including crosspiece 502.

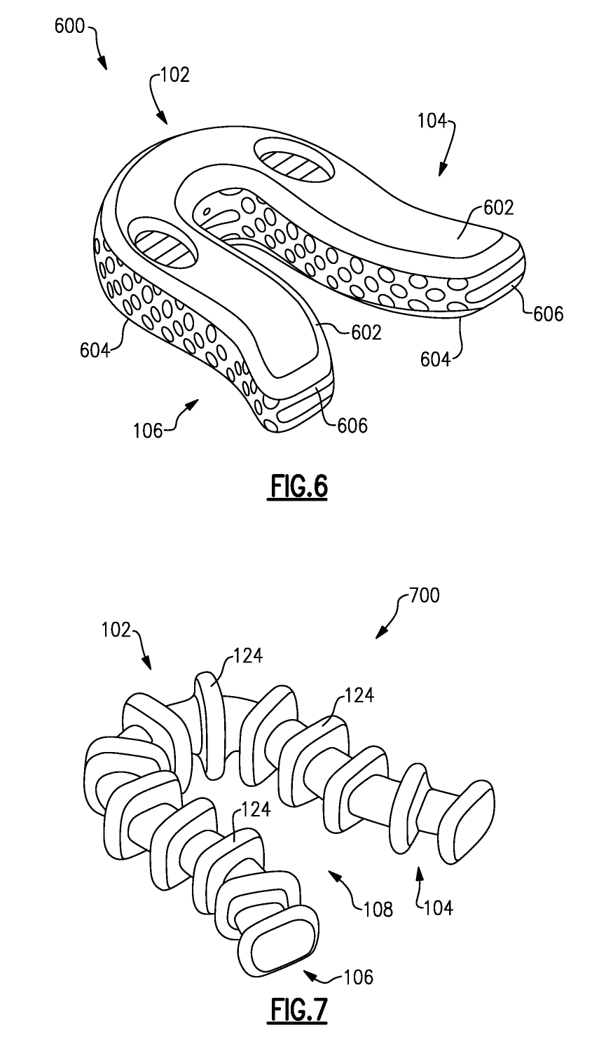

FIG. 6 is yet another example of a chew 600 having a geometry corresponding to the mouth of an animal. Chew 600 is composed of multiple layers 602, 604, 606, with different layers having different textures. Each layer 602, 604, 606 is a planar portion of the chew 600 having a consistent internal physical structure. All of layers 602, 604, 606 can be composed of the same edible animal composition and formed simultaneously (e.g., in a single molding step), or the composition of layers 602, 604 and 606 can be different and formed in sequential steps. Even in those embodiments wherein layers 602, 604 and 606 are comprised of the same composition, layers 602, 604, 606 can have a different internal physical configuration/structure. Such a varied structure can not only provide chew 600 with structural stability, but also, can increase animal interest in chew 600 as varied structural or compositional properties may provide a varied consuming experience. In an example, the chew 600 can be fabricated by 3D printing.

In the chew 600 shown in FIG. 6, the upper and lower layers 602, 604 have a solid texture, and an inner layer 606 disposed between the upper and lower layers 602, 604 has a lattice texture. By the phrase “solid texture”, it is meant that layers 602 and 604 have an internal structure without visibly discernable spaces. The lattice texture of inner layer 606 is characterized by an internal structure comprised of crosspieces arranged to provide structural stability to the layer. As such, the lattice texture includes many visible internal spaces, in which no edible animal composition is present. Utilizing this, or other lattice texture in one or more layers of chew 600 enables less edible animal material to be used, reducing the caloric intake of the chew 600 as compared to a solid chew. A lattice texture can also further improve the tooth cleaning ability of the chew by providing surfaces throughout that can contact the teeth of an animal as the chew is consumed. Any of the chews described herein can include multiple textures (e.g., a lattice texture and a solid texture) in either a layer form as described with respect to chew 600 or otherwise, such as having a different texture in the area surrounding canine indentation 118 than in other areas of the chew.

FIG. 7 is still another example of a chew 700 having a geometry corresponding to the mouth of an animal. Chew 700 includes a base portion 102 and arms 104, 106 having similar characteristics to those described above. Chew 700 also includes transverse flanges 124, however, chew 700 does not include inner and outer flanges 120, 122.

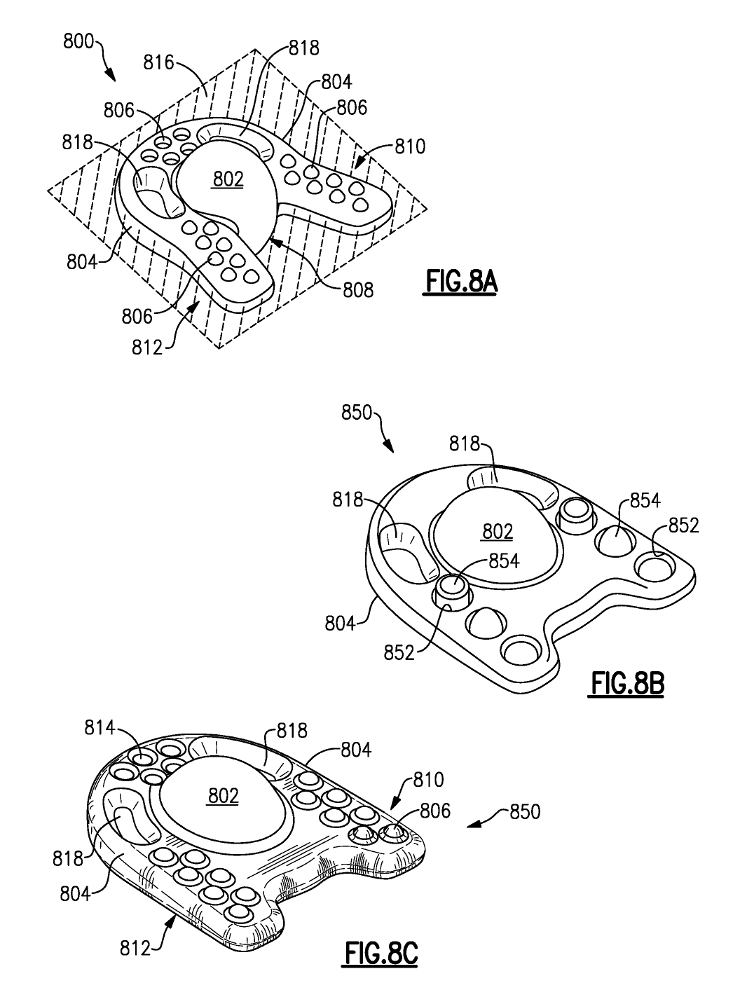

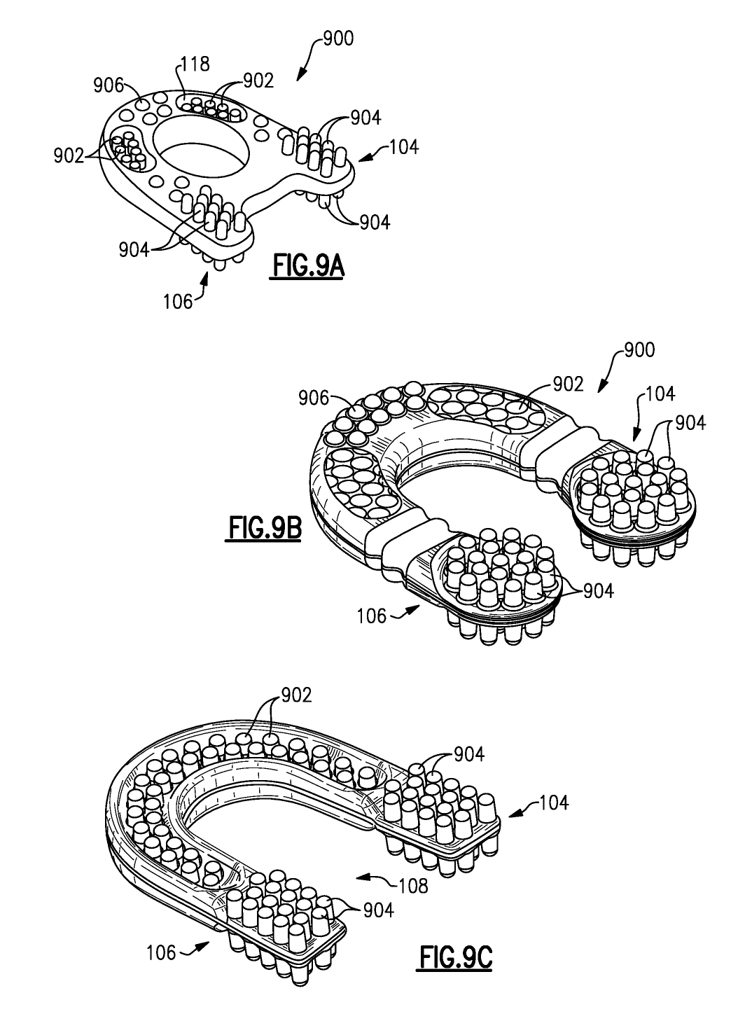

FIGS. 8A, 8B and 8C show examples of chews incorporating a dome, hemisphere or sphere within elongated space 108. As shown in FIG. 8A, chew 800 has a geometry that provides for a large number of teeth of an animal to contact the chew 800 during a bite. Similar to the chews described above, chew 800 has a body with an edible animal chew composition. The body defines a sphere 802 disposed generally central to the chew 800, within elongated space 108. Arms 810 and 812 can include a flange 804 extending inwardly toward the sphere 802, within longitudinal plane 116 of the chew 800. In the example shown in FIG. 8A, the flange 804 extends around a portion of the circumference of an intersection of the sphere 802 and the longitudinal plane 116. In the example shown in FIG. 8A, the flange 804 extends around more than half of the circumference. In other examples, however, the flange 804 may extend around a different percentage of the circumference, or around the entire circumference of the intersection of the sphere 802 and the longitudinal plane 116. In an example, the flange 804 extends outward from the sphere 802 in the range 0.1 to 0.5 inches.

The sphere 802 can aid in self-alignment of the chew 800 in the mouth of the animal. Since the sphere 802 projects upward from the flange 804, the sphere 802 will naturally be positioned against the roof of the mouth during a bite. This placement of the sphere 802, places the teeth of the animal onto the flange 804, thus self-positioning the chew 800 in the mouth of the animal. To fit properly in an animal's mouth, the sphere 802 can have a diameter in the range of 0.25 to 2.5 inches. The sphere 802 can, but does not need to have a partial spherical shape, such as a hemispherical shape, or, a shape that is not perfectly round. In any case, the sphere 802 is a rounded surface projecting upwards from the flange 804. In examples in which the sphere 802 is not perfectly round, its “diameter” can be measured from the flange 804 on one side to the flange 804 on the opposite side of the sphere 802. Additionally, the highest point of the sphere 802 can project upward from the longitudinal plane 116 a distance in the range of 0.1 to 1.25 inches. The longitudinal plane 116 can be considered to extend through a middle of the flange 804, and will oftentimes define a plane of symmetry, as the top half of the flange 804 will be symmetric with the bottom half of the flange 804. In the example shown in FIG. 8A, the sphere 802 provides a ball geometry in the central portion of the flange 804. In other examples, however, a hemisphere or dome may be provided so that there is no lower curved surface 808. Sphere 802 provides chew 800 with two plane symmetry similar to the chews discussed above. That is, the chew 800 can be symmetric about the longitudinal plane 116 as well as a plane perpendicular to the longitudinal plane 116 extending through the middle of the sphere 802.

Similar to the chews described above, a height (distance normal to the longitudinal plane 816) of the flange 804 can decrease from the side opposite the distal ends of the arms 810, 812 to the distal ends of the arms 810, 812. Additionally, the flange 804 can extend out from the domed surface 802 in a direction parallel with the longitudinal plane 816 for a distance in the range of 0.25 to 2 inches. In an example, the top and bottom surfaces of the flange 804 can comprise flat unitary portions having one or more features 806 defined therein to aid in contacting the varied surfaces of the teeth. The one or more features 806 can include nubbins projecting upwards and/or small indentations recessing inward. Similar to some of the chews described above, the chew 800 can also include upper and/or lower canine indentations 818 disposed in a position corresponding to canine teeth. A thin layer of edible animal composition can be included in between the upper and lower canine indentations 818.

First and second arms 810, 812 extend laterally to provide flange 804. The arms 810, 812 are similar to the distal half of arms 104, 106 of the chews above in orientation, since the arms 810, 812 are likewise configured to align with the teeth of an animal. In an example, the sphere 802 can be replaced with a dome, and can be hollow underneath, formed by a layer of the animal chew that projects upwards and extends outward to the flange 804. This is in contrast to the flange 804, which can be a solid structure of animal chew composition (i.e., not hollow). Use of a dome or hemisphere in place of sphere 802 would reduce the calorie content of the chew 800 relative to the calorie content when a sphere is used. Alternatively, sphere 802 could be hollow, or aerated to lower the calorie content of chew 800.

FIG. 8B is another example of a chew 850 including hemisphere 802. Because a hemisphere is used in place of a sphere, the center part of the bottom surface (reverse of the hemisphere 802) can be flat. Also, the flange 804 of chew 850 extends around the entire intersection of the longitudinal plane 816 and the hemisphere 802.

Additionally, chew 850 defines one or more sockets 852 for holding a treat 854 for the animal. The treats 854 are separate articles from the main body of the chew 850 and need not have an animal chew composition. For example, the treats 854 can be included to provide additional flavor for an animal and do not need to be contribute to the tooth cleaning abilities of the chew 850. As such, the treats 854 can have a lasting time of less than 30 seconds. In an example, the chew 850 and different shapes and/or flavors of treats 854 can be sold separately allowing a user to customize which treats are provided to their animal. The geometries of the treat(s) 854 and the socket(s) 852 can coordinated such that the treats are held within the sockets by friction fit. Thus, the user can push a treat 854 into each of the one or more sockets 852 of the chew 850 and then provide the chew 850 to the animal.

FIG. 8C is another example of a chew 850, wherein sockets 852 are not provided. The chew 850 as shown in FIG. 8C instead includes a plurality of protrusions 806 on the first and second arms 810, 812 and a plurality of indentations 814 in the base portion of chew 850.

FIGS. 9A, 9B and 9C show additional examples of a chew 900 having a geometry corresponding to the mouth of an animal. As shown in FIGS. 9A-9C, chew 900 has a ‘U’ shaped geometry that defines arms 104, 106. Chew 900 includes a plurality of bristles 902, 904 comprised of the same edible animal chew composition as the remainder of chew 900, or a different edible animal chew compositions, extending upward and downward normal to a longitudinal plane 116 of the chew 900. In chew 900 shown in FIGS. 9A and 9B, first subsets of bristles 902 are disposed in canine indentations 118 of the chew 900 and second subsets of bristles 904 are disposed at the distal ends of the arms 104, 106. Bristles 902 extend upwardly from the bottom of canine indentation 118 in the chew 900. Bristles 904 extend from the main upper and lower surfaces of the chew 900 in each of FIGS. 9A-9C. The bristles 902, 904 provide additional and varied surfaces to contact various surfaces of the teeth of the animal. Bristles 902, 904 can be disposed in other locations on a chew in other examples. As shown in FIG. 9C, bristles 902 may be provided in an indentation that is provided extending from a proximate portion of the first arm, through the base portion and into a proximate portion of the second arm. Further, chew 900 can include protrusions 906 in any desired location, such as in the base portion of chew 900 as shown in FIGS. 9A and 9B.

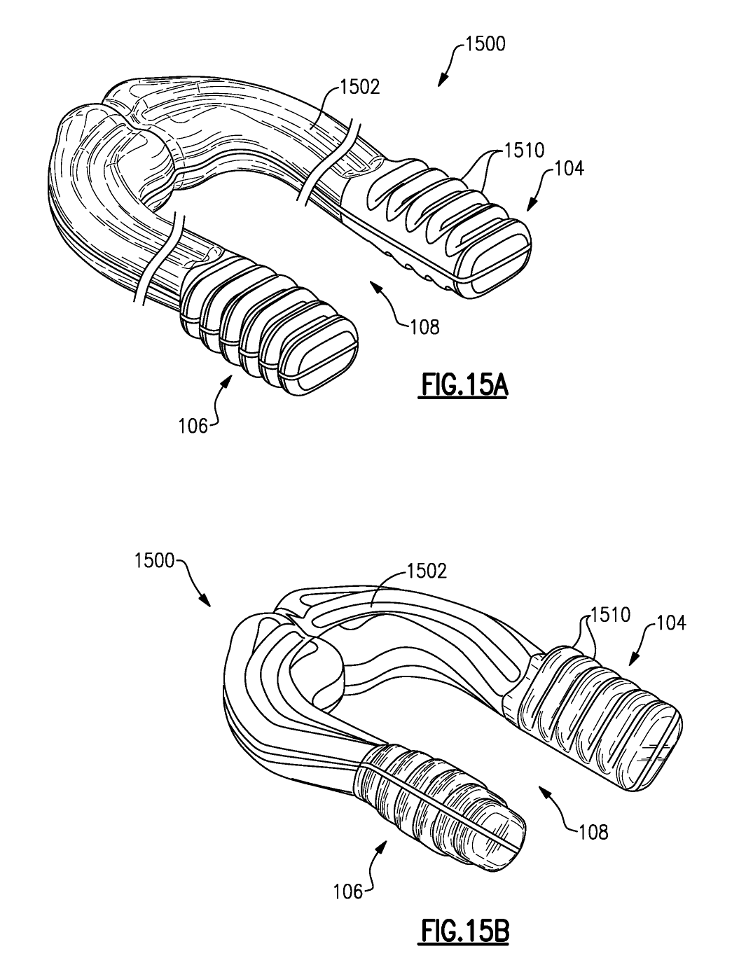

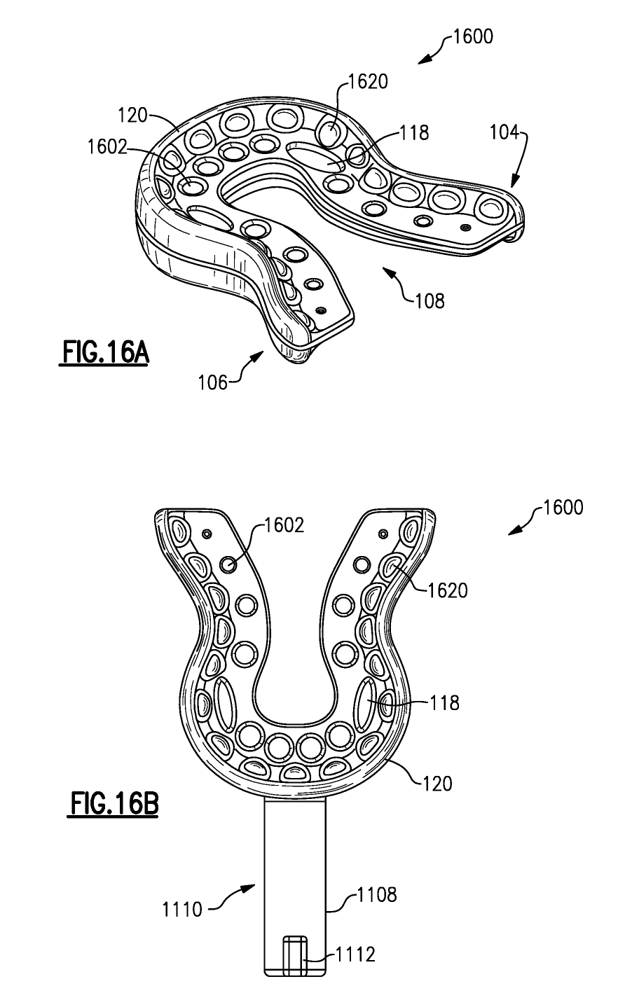

FIGS. 15A and 15B show another example of chew 1500. As shown in FIGS. 15A and 15B, chew 1500 exhibits the U-shaped geometry described above in connection with FIGS. 1-9, albeit with no crosspiece or dome, sphere or hemisphere within elongated space 108. Chew 1500 includes a trough 1502 that extends from the end of arm 106 proximate the base portion, through the base portion and through a portion of arm 104 proximate the base portion. Ridges 1510 are provided at the distal ends of arms 104 and 106. Chew 1500 as shown in FIG. 15B is identical to that shown in FIG. 15A, with the exception that the distal ends of arms 104 and 106 are rotated about a longitudinal axis of each so that the ridges 1510 are no longer within or parallel to longitudinal plane 116.

FIGS. 16A and 16B show another example of an animal chew adapted to fit within an animal's mouth. Chew 1600 is similar to chew 400, as shown in FIGS. 4A and 4B above, in that chew 1600 includes a plurality of protrusions 1620 and smaller indentations 1602 on the top and bottom surfaces. However, protrusions 1620 are provided on the lateral internal surfaces of outer flange 120, rather than being provided on an upper horizontal surface of the chew.

Example dimensions for chews not including a dome, hemisphere or sphere within elongated space 108, i.e., the chews shown in FIGS. 1-7 and 15-16 are as follows. Example dimensions for the chews 100-700, 1500 and 1600 for a small dog are: a height (from the top edges of the upper outer/inner flanges 120, 122 or other uppermost surface to the bottom edges of the lower outer/inner flanges or other lowermost surface) in the range of 0.25 to 0.75 inches, a length of the arms 104, 106 from the base line 110 in the range of 0.5 to 2.75 inches, overall length (dimension of the chew perpendicular to base line 110 within the longitudinal plane 106) of 1 to 3 inches, a transverse dimension (parallel to the base line 110 in the longitudinal plane 110) of the elongated space 108 in the range of 0.25 to 1 inches, and an overall width (dimension of the chew parallel to base line 110 within the longitudinal plane 106) in the range of 0.5 to 1.5 inches. Example dimensions for the chews 100-700, 1500 and 1600 for a medium dog are: a height in the range of 0.5 to 1.25 inches, a length of the arms 104, 106 from the base line 110 in the range of 1.75 to 3.75 inches, overall length (dimension of the chew perpendicular to base line 110 within the longitudinal plane 106) of 2 to 4 inches, a transverse dimension (parallel to the base line 110 in the longitudinal plane 110) of the elongated space 108 in the range of 0.375 to 1.5 inches, and an overall width (dimension of the chew parallel to base line 110 within the longitudinal plane 106) in the range of 1 to 2 inches. Example dimensions for the chews 100-700, 1500 and 1600 for a large dog are: a height in the range of 1 to 2 inches, a length of the arms 104, 106 from the base line 110 in the range of 2.75 to 5.75 inches, an overall length (dimension of the chew perpendicular to base line 110 within the longitudinal plane 106) of 3 to 6 inches, a transverse dimension (parallel to the base line 110 in the longitudinal plane 110) of the elongated space 108 in the range of 0.5 to 2.5 inches, and an overall width (dimension of the chew parallel to base line 110 within the longitudinal plane 106) in the range of 2 to 3 inches.

Example dimensions for chews including a dome, hemisphere or sphere within elongated space 108, i.e., chews 800 and 850 as shown in FIGS. 81, 8B and 8C are as follows. Example dimensions for a small dog are: a height of the flange 804 (or main upper surface) in the range of 0.25 to 0.75 inches, an overall length (dimension of the chew perpendicular to base line 110 within the longitudinal plane 106) of 1 to 3 inches, and an overall width (dimension of the chew parallel to base line 110 within the longitudinal plane 106) in the range of 0.5 to 1.5 inches. Example dimensions for the chews 800, 850, 900 for a medium dog are: a height of the flange 804 in the range of 0.5 to 1.25 inches, an overall length (dimension of the chew perpendicular to base line 110 within the longitudinal plane 106) of 2 to 4 inches, and an overall width (dimension of the chew parallel to base line 110 within the longitudinal plane 106) in the range of 1 to 2 inches. Example dimensions for the chews 800, 850, 900 for a large dog are: a height of the flange 804 in the range of 1 to 2 inches, an overall length (dimension of the chew perpendicular to base line 110 within the longitudinal plane 106) of 3 to 6 inches, and an overall width (dimension of the chew parallel to base line 110 within the longitudinal plane 106) in the range of 2 to 3 inches.

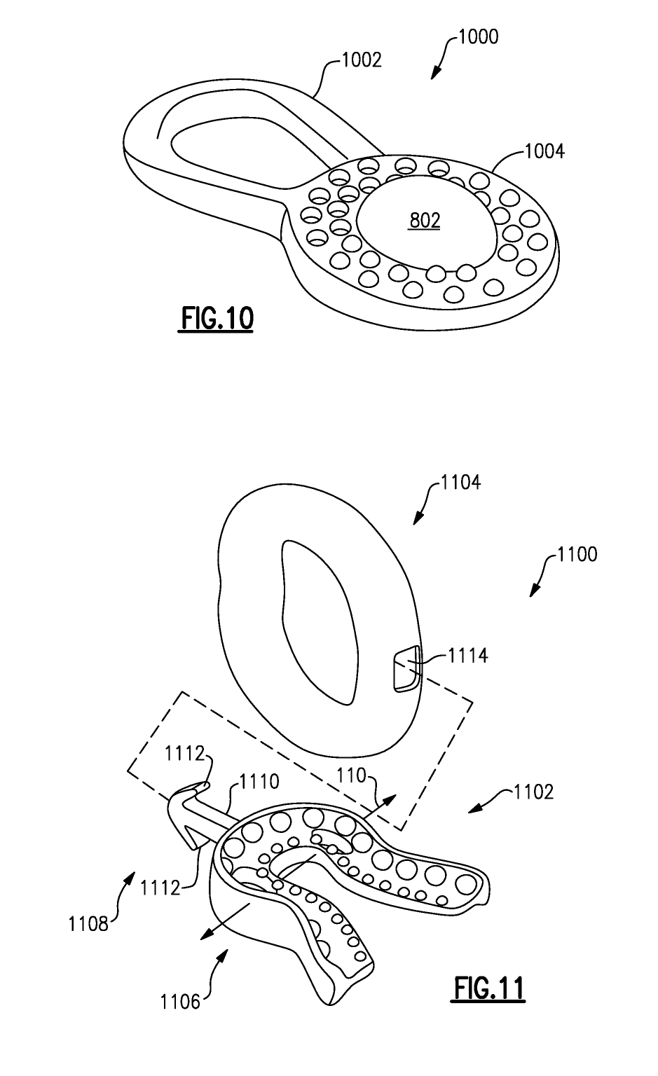

FIG. 10 is an example of another type of chew 1000. Chew 1000 includes a handle 1002 extending from a mouthpiece 1004. The handle 1002 and the mouthpiece 1004 are portions of a single monolithic unit. This single monolithic unit has an edible animal chew composition as discussed above. The mouthpiece 1004 is a portion of the chew 1000 that is configured to be placed into an animal's mouth while the handle 1002 is being held by a user. Including a handle 1002 on the chew 1000 enables a user to help position the mouthpiece 1004 in the mouth of an animal, to improve the number of teeth that come into contact with the mouthpiece 1004. For example, with the aid of the handle 1002, the user can position the mouthpiece 1004 such that the animal's teeth are aligned with the base portion and arms of the mouthpiece 1004. The mouthpiece 1004 can have any desired geometry. In some examples, the mouthpiece 1004 has a geometry as described above with respect to the chews 100-900.

The handle 1002 extends from the mouthpiece 1004 in such a manner that the handle 1002 can be outside of the animal's mouth while the mouthpiece 1004 is inside the animal's mouth. In examples where the mouthpiece 1004 has a geometry as described above with respect to FIGS. 1-9, the handle 1002 can extend from the base portion 102 of the mouthpiece 1004, in a direction opposite that of arms 104, 106, 810, 812.

The handle 1002 has a geometry that is configured to enable easy grasping by a user. For example, the handle 1002 can include an elongated member that is configured to have a user grasp around it. In the example shown in FIG. 10, the elongated member is generally cylindrical in a cross-section about a rotational axis within the body of the elongated member, and is curved into a loop. The user can grasp the handle 1002 by extending one or more fingers through the loop and grasping the outer portion of the looped elongated member. Although the handle 1002 is shown in FIG. 10 as having a cylindrical cross-section and a looped shape, other cross-sections and shapes can be used. Additionally, the handle 1002 is shown as extending in a longitudinal plane of the mouthpiece 1004. In other examples, the handle 1002 can extend in other planes, such as in a plane perpendicular to the longitudinal plane.

The handle 1002 is a single monolithic unit with the mouthpiece 1004, and is also composed of edible animal chew material. Thus, once used to provide the animal the chew, and possibly to assist with the positioning of the chew within the animal's mouth, the user can simply let go of the handle 1002 and allow the animal to consume the chew 1000, and eventually, the handle.

FIG. 11 is an example of an animal chew providing system 1100, which includes a chew 1102 and a connectable handle 1104. The chew 1102 is a monolithic unit with an edible animal chew composition. The handle 1104 is a non-edible unit that is configured to be grasped by a user. In an example, the handle 1102 is composed of a durable plastic. The handle 1104 and the chew 1102 are configured to be connected together. Similar to the chew 1000 described above, providing a handle for the chew 1102 can enable the user to actively position the chew 1102 within the mouth of an animal.

The chew 1102 is composed of a mouthpiece 1106 and a stem 1108 extending from the mouthpiece 1106. The mouthpiece 1106 is configured to be inside the animal's mouth while the user is holding the handle 1104, while the handle 1104 is attached to the chew 1102 via stem 1108. The mouthpiece 1106 can have any suitable geometry. In some examples, the mouthpiece 1106 has a geometry as described above with respect to the chews 100-900.

The stem 1108 extends from the mouthpiece 1106 in such a manner that the stem 1108 can be outside of the animal's mouth while the mouthpiece 1106 is inside the animal's mouth. In examples where the mouthpiece 1106 has a geometry as described above with respect to FIGS. 1-9, the stem 1108 can extend from the base portion of the mouthpiece 1106, reverse of the elongated space and/or sphere, dome or hemisphere 802.

The stem 1108 provides the means of connecting the chew 1102 to the handle 1104. The stem 1108 includes an elongated member having a main body 1110 with one or more tabs 1112 projecting from the main body 1110. The main body 1110 can project outward from the mouthpiece 1106 within the longitudinal plane 116 of the mouthpiece 1106 and perpendicular to the base line 102. The main body 1110 can have any desired cross-section. The tabs 1112 project outward from the main body 1110 in a manner to create a surface/structure which can contact an opposing surface 1114 on the handle 1104 to resist separation of the chew 1102 from the handle 1108. In the example shown in FIG. 11, the tabs 1112 comprise backward angled projections that can hook onto, or bear against, an opposing surface 1114 of the handle 1104. In other examples, the tabs 1112 can have other geometries, such as projecting at a 90-degree angle from the main body 1110.

The handle 1104 has a geometry that is configured to enable easy grasping by a user. For example, the handle 1104 can include an elongated member as is described with respect to handle 1002 of FIG. 10. The handle 1104 shown in FIG. 11 extends perpendicularly to the longitudinal plane 116 of the mouthpiece 1106 when tabs 1112 of stem 1108 are engaged with the back wall of aperture 1114 in handle 1104. In other examples, however, the handle 1104 can extend in other planes, such as in the longitudinal plane 116 of the mouthpiece 1106 when attached to chew 1102. In any arrangement, a portion of handle 1104 will be between the mouthpiece and a user's hand grasping the handle when the handle 1104 is attached to chew 1102, thereby protecting the users hand from the teeth of the animal.

The handle 1104 can include one or more features configured to engage with the stem 1108 of chew 1102 in order to connect the chew 1102 to the handle 1104. The chew 1102 is desirably connected to the handle 1104 in a rigid manner, that is, such that chew 1102 moves with the handle 1104 like the chew 1102 is a monolithic unit with handle 1104. Such a rigid connection provides good control over the placement of the mouthpiece 1106 in an animal's mouth.

In the example shown in FIG. 11, the one or more features of the handle 1104 for engaging with the chew 1102 include an aperture 1114. The aperture 1114 is disposed in a wall of the handle 1104, the wall having a front (exterior) surface and a back (interior) surface. In this example, the portion of the handle 1104 defining the aperture 1114 is hollow, such that the aperture 1114 extends from the outside of the hollow portion to the inside thereof. The stem 1108 is configured to be inserted into the aperture 1114 such that the tabs 1112 are pushed past the wall and catch/bear against the back surface of the wall to resist extraction of the stem 1108 from the aperture 1114. The angled configuration of the tabs 1112 enables the tabs 1112 to flex inward when being pushed through the aperture 1114, and spring out once they are past the back surface of the wall defining the aperture 1114. Once the tabs 1112 spring out, the backward angle of the tabs 1112 resists flexing that would allow the stem 1108 to be extracted from the aperture 1114. Thus, the tabs 1112 enable interlocking of the handle 1104 and the chew 1102, while resisting disconnection.

In an example, the tabs 1112 are configured to give way after a certain amount of chewing by an animal on the mouthpiece 1106. For example, while an animal is chewing on the mouthpiece 1102, the animal is likely to pull on the chew placing force on the tabs 1112 as they bear against the back surface of the wall surrounding aperture 1114. The tabs 1112 can be configured to give way (e.g., flex or break off) allowing the stem 1108 to be extracted from the aperture 1114, thereby allowing the chew 1102 to disconnect from the handle 1104. Once the handle 1104 has been so released, the animal may chew and consume chew 1102. In an example, the tabs 1112 have at least a portion thereof with a cross-section substantially smaller than a cross section of the smallest portion of the main body 1110 of the stem 1108 such that the tabs 1112 give way readily and prior to breaking or other structural failure of the stem 1108. In this way most, if not all, of the stem 1108 remains attached to the mouthpiece 1106 after disconnection of the chew 1102 from the handle 1104, enabling easier removal of the handle and chewing/consumption of the entire chew 1102.

Providing a non-edible handle that is connectable to a chew, enables a chew to be positioned by an owner within the mouth of the animal, with a lower caloric intake for the animal. Additionally, a connectable non-edible handle is re-useable, providing cost savings to both the consumer and manufacturer. Because the chew is provided with a composition and features that perform the teeth cleaning function, manipulation by a user beyond the initial placement is not contemplated or required in order for the present chews to clean the teeth of the animal.

FIG. 12 is another example of an animal chew providing system 1200 including an (edible) chew 1202 and a non-edible connectable handle 1204. The chew 1202 is shown in a cut-away view in which a portion of the mouthpiece 1106 is cut-away. In this example, the tabs 1112 on the main body 1110 of the stem 1108 of chew 1202 project at a 90-degree angle outward from the main body 1110. Also, the aperture 1114 of the handle 1204 defines notches for insertion of the tabs 1112 there through. In use, the stem 1108 can be inserted into the aperture 1114 with the tabs 1112 aligned with notches in the aperture 1114. Once the tabs 1112 are past the back surface of the wall defining the aperture 1114, the chew 1202 and thus stem 1108 can be rotated axially (e.g., 90-degrees) with respect to the handle 1204. In this rotated position, the tabs 1112 will bear against the back surface of the wall defining the aperture 1114, thereby resisting extraction of the stem 1108 from the aperture 1114. Once the chew has been positioned within the mouth of the animal, the user can rotate the handle 1202 causing the tabs 1112 to realign with the notches in the aperture 1114, and pull the handle off of stem 1108.

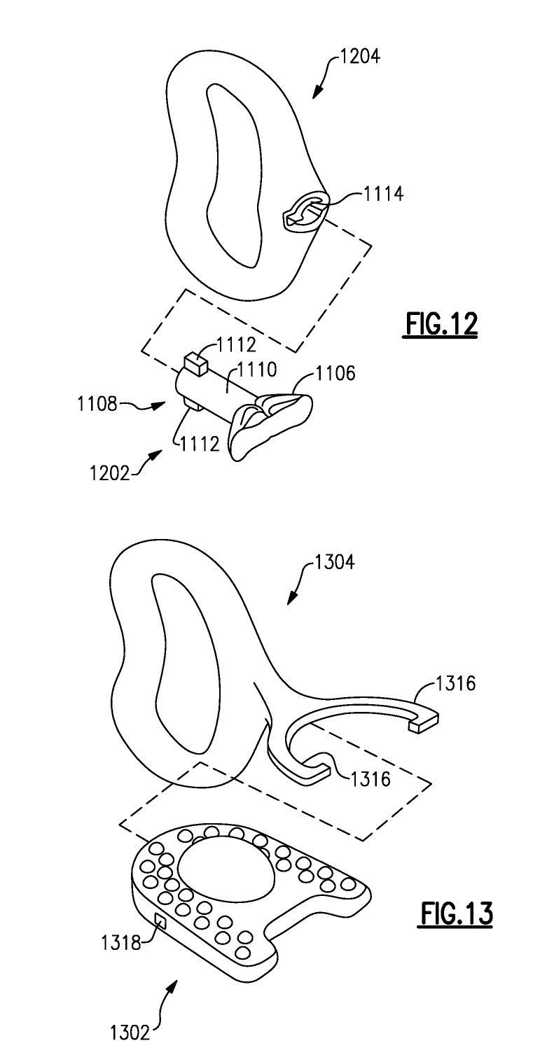

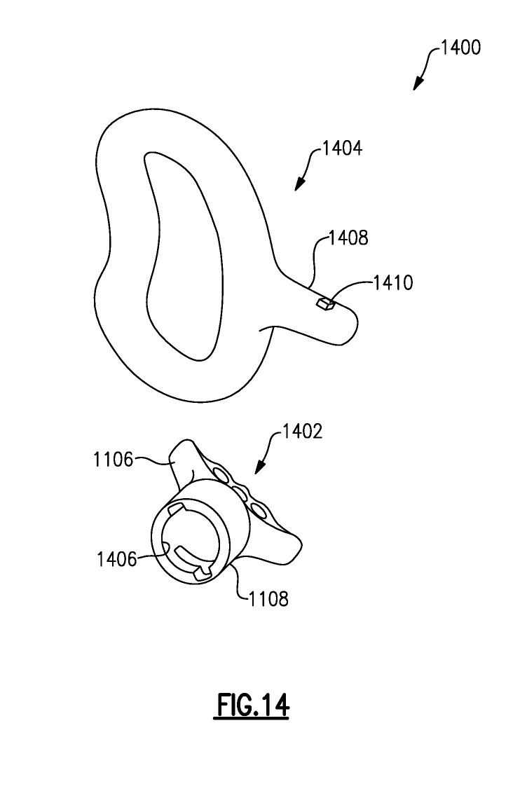

FIG. 13 is yet another example of an animal chew providing system 1300 including a chew 1302 and a non-edible connectable handle 1304. The chew 1302 can have any suitable geometry, including the example geometry shown in FIG. 13, which is similar to that of chew 800. Chew 1302 includes opposing notches 1318 that are configured for interlocking with tabs on the opposing arms 1316 of the handle 1304. The arms 1316 of the handle 1304 are configured such that the tabs thereon can extend into both notches 1318 at the same time to hold the chew 1302 in between the arms 1316 and thereby connect the chew 1302 to the handle 1304. In an alternative example, the chew 1302 does not have the notches 1318 and is held in place between the arms 1316 by friction due to a snug fit of the chew 1302 between the arms 1316. The notches 1318 are disposed on edges of the chew 1302, the edges being transverse to the longitudinal plane 116 of the chew 1302. Notably, in this example, the chew 1302 need not have a stem 1108, as the handle 1304 engages directly with, or features provided within, the edges of the chew 1302. Once placed in the mouth of the animal, minimal retentive force by the animal while the owner pulls on the handle 1304 will allow the arms 1316 to release from the chew, thereby releasing the handle 1304.

FIG. 14 is still another example of an animal chew providing system 1400 including a chew 1402 and a non-edible connectable handle 1404. The chew 1402 is shown in a cut-away view in which a portion of the mouthpiece 1106 is cut-away. In this example, the stem 1108 of the chew 1402 defines an axial aperture 1406 in a distal end of the stem 1108. The handle 1404 can include a stem 1408 having one or more tabs 1410 provided thereon. The stem 1408 can be configured to fit in the aperture 1406 of the chew 1402 with the tabs 1410 aligned with notches defined in the aperture 1406. When the tabs 1410 are inserted into the aperture 1406 a distance such that the tabs 1410 reach a point where they can be rotated (e.g., due to a groove in the internal surface of the aperture 1406), the chew 1402 can be rotated (e.g., 90 degrees) with respect to the handle 1404 causing the tabs 1410 to bear against an opposing surface (e.g., edge of groove) of the chew 1402.

As should be understood, other means of connecting a chew and a non-edible handle are also possible.

Although various specific examples have been described and shown herein, it should be understood that features from one example chew herein and/or handle can be mixed and matched with features from other example chews herein as appropriate. Thus, an example chew including features from multiple of the example chews described herein is contemplated.

In an example, animal chews described herein can be manufactured by initially forming a plurality of pellets from an animal chew composition. The pellets can be formed by admixing the desired ingredients, extruding the mixture, and dicing the resulting extrudate to form the pellets. The pellets can then be subsequently melted and formed into the geometry of the animal chews described herein by molding the pellets in a mold corresponding to the desired geometry. The molding is preferably injection molding. One skilled in the art, however, will readily recognize that the molding could also be compression molding. In other examples, pellets are not initially formed. Instead, the desired ingredients are admixed and added directly to the injection molder, so long as the parameters are controlled to achieve thermoplasticization of the formulation. Example process for manufacturing the chews herein are described in the aforementioned WO 2014/066438 and WO 2014/155113.

In certain embodiments, a chew described herein can have a mono-component, homogeneous composition, in which the entire chew is formed of a common animal chew material. In some embodiments, a chew of the present disclosure can comprise a dual texture and/or a multi-texture. In certain embodiments, an animal chew of the present disclosure comprises a first component (e.g. a first layer) having a first texture and a second component (e.g. a second layer) having a second texture. And in some embodiments, for example, an animal chew of the present disclosure may comprise one or more of: a third component having a third texture, a fourth component having a fourth texture, and a fifth component having a fifth texture. Moreover, in some embodiments of a multi-texture chew of the present disclosure, one or more of the textured components may have the same texture or all of the textured components may have different textures. Additionally, in certain embodiments, each textured layer of the multi-texture chews, such as multi-texture chews 600 and 700, can have a respective mono-component, homogeneous composition, features such as the bristles in chew 900 can have a mono-component, homogeneous composition, while the main body of chews 900 can have a different mono-component, homogeneous composition.

Methods of cleaning the teeth of an animal using the present chews are also provided. The methods involve providing a chew as described herein and/or positioning the chew within the animal's mouth using the positioning or self-positioning features described herein, removing any reusable positioning features and allowing the animal to consume the chew. The consumption of the chew by the animal causes friction between the material of the chew and the animal's teeth thereby cleaning the teeth. Manipulation by the owner beyond the initial providing/positioning of the chew within the mouth of the animal is not required.

The edible animal chews described herein can exhibit a cohesiveness measured by Texture Profile Analysis of 0.55 or greater. Preferably, the cohesiveness is 0.57 or greater, or 0.60 or greater. Even more preferably, the cohesiveness is 0.61 or greater, or 0.62 or greater. Such high cohesiveness values are associated with the ability of the chew to retain its structure and so provide an increased cleaning efficacy when consumed by an animal.

Preferably, the chews described herein exhibit a value of cohesiveness/density of at least 0.65, preferably at least 0.70, preferably at least 0.75, preferably at least 0.80, preferably at least 0.85, preferably at least 0.90, preferably at least 0.95, and preferably at least 1.0 g-1 cm3. Preferably, the value of cohesiveness/density is not more than about 1.8, preferably not more than about 1.7, preferably not more than about 1.6, and preferably not more than about 1.5 g-1 cm3. In an example, the edible animal chews described herein exhibit a cohesiveness measured by Texture Profile Analysis of 0.55 or greater and a density of 1.0 g cm-3 or less.

In an example, the edible animal chews described herein have a resilient texture that exhibits a relative rebound of 9.25% or greater, preferably at least 10%, preferably at least 11%, more preferably 12% or greater. The relative rebound characterizes the ability of the edible animal chew to recover after being penetrated by an animal tooth. A relative rebound of 9.25% or greater can be correlated with an increased ability of a chew to maintain or improve the oral health of the animal. Just as with cohesiveness, and the cohesiveness/density ratio described above, an increased relative rebound is indicative of an increased ability of the chew to recover after deformation, which has been correlated with an increased ability to maintain or improve the oral health of an animal, while maintaining excellent lasting time.

The ‘resilient texture’ of the edible animal chew refers to the edible animal chew's ability to react at least partially elastically to deformation caused by a penetrating animal tooth. In other words, it refers to the edible animal chew's ability to at least partially return to its original shape after being deformed by a penetrating tooth. As should be understood, a given example animal chew can have both the cohesiveness and the resilient texture described herein.

The resilient texture of the edible animal chews described herein can further be characterized by a peak force (measured as described herein) of 9 kgf or greater. Such a peak force provides suitable resistance to the animal tooth to assist in the cleaning of the tooth during the chewing of the chew while providing excellent lasting time.

The resilient texture may also be characterized by a stress, derived from hardness measured by Texture Profile Analysis (as described herein), of 0.25 kg mm-2 or less, preferably 0.22 kg mm-2, preferably less than 0.20 kg mm-2, preferably less than 0.18 kg mm-2, preferably less than 0.16 kg mm-2, preferably less than 0.15 kg mm-2. This ensures that the chew is not so hard as to present a significant fracture risk to the teeth of the animal. The stress is preferably greater than 0.1 kg mm-2 so as to provide resistance to the animal's tooth when consumed.

The absolute value of the rebound exhibited by the edible animal chew of the present invention may be 5 kgf mm or greater, preferably 5.5 kgf mm or greater, which can correlate with an improved teeth cleaning ability in an edible animal chew.

Another method of characterizing the resilient texture of the edible animal chews described herein is the Corrected Grip and Abrasion (CGA) test. This test is explained in detail below. It is preferred that the CGA test gives a positive, non-zero value for the CGA parameter, i.e. a CGA parameter value of greater than zero. It is preferred that the CGA parameter is greater than 1 kgf, greater than 2 kgf, greater than 3 kgf, or greater than 4 kgf. It is especially preferred that the CGA test gives a value for the CGA parameter of between 4 and 20 kgf.

### (i) Rebound Measurement

The rebound measurements are taken using a flat ended conical probe fitted to a Stable Microsystems XHDi texture analyzer. The flat ended conical probe has a 10° opening angle and a flat end that is 2 mm in diameter. The probe is 50 mm in length and is constructed from stainless steel.

The rebound measurement is performed on a sample with a thickness greater than 10 mm. The probe is then set up to penetrate to a set depth of 10 mm into the sample (ensuring that the probe does not travel all the way through the sample) at a speed of 1 mm s-1. When the probe has travelled 10 mm into the sample, the probe's direction of travel is then immediately reversed and it is withdrawn from the sample at a speed of 1 mm s-1. During this process the force required to move the probe is recorded. The test is performed at 22° C. and the product is incubated at 22° C. prior to the testing to ensure it is of a uniform temperature.

From these measurements it is then possible to plot a variation in force with distance travelled by the probe. The force variation with distance is recorded for the initial downwards movement of the probe into the sample and then the upwards movement out of the sample. The area under the force profile represents the energy required. The force required to move the probe increases as the probe is inserted further into the sample. When the probe's direction is reversed, and the probe starts to be withdrawn, the force starts to decrease. The force required to maintain the speed of 1 mm s-1 is observed to be positive during the withdrawal for a chew of the present invention. This indicates that work has to be done to stop the probe from being pushed out further by the sample. Therefore, this measurement is indicative of the tendency of the sample to re-heal and close up the hole created by the probe. Finally, near the end of the withdrawal of the probe the force turns negative as energy is being expended to continue the removal of the probe. This section of the measurement is indicative of the sample exerting a grip on the probe stopping it from leaving the sample.

The insertion energy, which represents the energy required to insert the probe to a distance of 10 mm into the sample, is the area under a force-distance plot up to a distance of 10 mm. The rebound energy (rebound), which is the energy required to stop the probe from being forced out at a speed greater than the 1 mm s-1 withdrawal speed used in the experiment, is the area under a force-distance plot after the 10 mm maximum distance until the force returns to zero. The grip energy, which represents the energy required to extract the probe from the sample, is the area under the force-distance plot after the force has returned to zero during the removal of the probe. The relative rebound energy is a measure of this rebound energy as a percentage of the insertion energy, i.e. relative rebound energy=(rebound energy)/(insertion energy)×100. The peak force is the highest force experienced during the experiment, and is typically the force at the maximum distance of 10 mm.

There can be a correlation between the rebound energy and the effectiveness of teeth cleaning exhibited by a chew, as well as a correlation between the relative rebound energy and the effectiveness of teeth cleaning exhibited by a chew. (ii) Corrected Grip and Abrasion parameter (CGA)

The Corrected Grip and Abrasion (CGA) method is a way to score the relative level of “drag” that a tooth surface may experience when acting upon the product from both the recoil and the toughness of the contact surface. In order to resolve this effect a penetration probe having a “screw-thread” section further up the shaft is utilized. This is to amplify the effects of drag at the contact surface via the introduction of a mutually “roughened” surface. The diameter of the main section of the probe is 6 mm whilst the narrowest and widest diameter limits of the “screw-thread” section are 5 and 7 mm respectively. The “screw-thread” section is 20 mm long whilst the smooth section of the probe between the tip and “screw-thread” onset is 30 mm.

Although denoted as a “screw-thread” section, this part of the probe is not in the form of a helical screw thread but is instead a series of circular ridges that run around the longitudinal axis of the probe. As noted above, each circular ridge extends to a circular diameter of 7 mm, while the indentation between adjacent circular ridges has a narrower diameter of 5 mm. There are 20 evenly-spaced ridges along the 20 mm of the probe that is the “screw-thread” section. Therefore, the ridges occur at a frequency of 1 ridge per mm along the longitudinal direction of the probe.

The test is performed on a sample with a minimum face area of 1 cm² and a thickness of 2 cm. The probe is set up to travel in the thickness direction of the sample and penetrate the face area. The test is performed at 22° C. and the product is incubated at 22° C. prior to the testing to ensure it is of a uniform temperature.

As the probe passes through the product (at 20 mm s-1) there are two points at which its passage is resisted by the product to give peak force maxima. The first occurs during the initial penetration of the tip whilst the second occurs when the screw-thread section passes through the product (all data is recorded from the penetrating stroke of the probe, no data from the withdrawal of the probe is considered).

To get a true interpretation of the drag over the screw-thread section a correction is applied. Clearly, because the first face of the screw-thread overshoots the main body of the probe in terms of its diameter, there is some contribution of a pseudo-penetrative element where the aforementioned face shears away some of the product. This contribution can be approximated as the product of the force maximum “P” and the ratio of the two-dimensional areas shown in the perspective plot above. Essentially the extra shear has been calculated as a predicted proportion of the penetration (P) peak. This is then subtracted from the drag (D) parameter to give the “corrected grip and abrasion” (CGA) parameter as described in the following equation:

$$CGA = D - ( ( \frac{( π \times {( 7 \div 2 )}^{2} ) - ( π \times {( 6 \div 2 )}^{2} )}{π \times {( 6 \div 2 )}^{2}} ) \times P )$$

A significant amount of drag will therefore result in a positive and non-zero CGA parameter, while an insignificant amount of drag will result in a zero or negative CGA parameter.

(iii) Texture Profile Analysis

Texture Profile Analysis (TPA) allows the determination of several parameters that characterize the texture of the sample. The sample is first incubated at 22° C. for 1 hour prior to testing. The samples are tested immediately after removal from the incubator. The sample is then cut transversally into slices of 10 mm thickness. These samples are laid flat in the center of a flat surface such that the sample is compressed in the longitudinal direction. Using a texture analyzer (Stable Micro Systems TA HD Plus) a compression platen of a size sufficient to compress the entire surface of the sample is used to compress the product to 50% strain, or 50% of its overall height at a speed of 1 mm/s. In the case of the 10 mm high sample, the distance to 50% strain is 5 mm. Once the required strain distance is reached, the probe is then moved upwards immediately at rate of 1 mm/s and stops 10 mm above the base plate, the original sample height. After completing the first compression cycle, the compression platen pauses for a period of 5 seconds in which the product, dependent on its material properties can recover some of its original shape and form. The second compression cycle is then carried out. The compression platen is moved down to the distance that was required to achieve 50% strain during first compression (in this case 5 mm) at a speed of 1 mm/s. After reaching the required strain distance, the probe is then moved upwards immediately at rate of 1 mm/s and stops at the original probe height.

The Texture Profile Analysis measurement can be presented as the force experienced by the probe against time elapsed. This emulates the compression from a first bite, followed by a second bite at the same location and is a well-established technique.

The first parameter of interest from this measurement is the hardness. This is the peak force of the first compression of the sample. This need not correspond to the point of deepest compression and can be normalized relative to the area of the sample upon which the platen acts to give a stress value. This value indicates the amount of resistance a tooth would encounter during a biting action. As noted above, a higher stress value can increase the risk of tooth fracture.

The second parameter of interest is cohesiveness. This is a measure of work during the second compression relative to the work during the first compression: Cohesiveness=A_3/A_1. Cohesiveness therefore represents how well the product withstands a second deformation relative to how it behaved under the first deformation and so is a good indication of the ability of the sample to maintain a resistance to subsequent bites and offer a continuing cleaning action for the animal's teeth.

The third parameter of interest is the instantaneous recoverable springiness (IRS), which is a measure of the springback during the first compression: IRS=L_2/L_1. IRS is therefore indicative of the springiness of the sample directly after the compressive downstroke.

The fourth parameter is the retarded recoverable springiness (RRS), which is a measure of how well the product physically springs back after it has been deformed during the first compression. The springback is measured at the downstroke of the second compression relative to the first compression: RRS=L_4/L_1. Therefore, RRS is indicative of the amount of springback before the second compressive downstroke.

The fifth parameter is the resilience, which is a measure of the area during withdrawal of the first compression relative to the area during the first compressive down stroke: Resilience=A_5/A_4. The resilience is indicative of how much work the sample does in trying to regain its original shape, and so is another indication of the instantaneous springiness of the sample.

The characteristics of the chew are preferably measured 56 days after the manufacture thereof, during which time each chew remains individually sealed in a sealed sachet which is held at ambient temperature (22° C.).

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure. Furthermore, the foregoing description is for the purpose of illustration only, and not for the purpose of limitation.

One of ordinary skill in the art will recognize that additional embodiments or implementations are possible without departing from the teachings of the present disclosure or the scope of the claims which follow. This detailed description, and particularly the specific details of the exemplary embodiments and implementations disclosed herein, is given primarily for clarity of understanding, and no unnecessary limitations are to be understood therefrom, for modifications will become obvious to those skilled in the art upon reading this disclosure and may be made without departing from the spirit or scope of the claimed invention(s).

1. An animal chew comprising:
a body having an edible animal chew composition, the body defining:
a base portion including
a first wing projection extending in the longitudinal plane, outward from the base portion proximate the base line, and in a direction approximately parallel with the base line; and
a second wing projection extending in the longitudinal plane, outward from the base portion proximate the base line, and in a direction approximately parallel with the base line;
a first arm extending from the base portion; and
a second arm spaced apart from the first arm and extending from the base portion,
wherein a longitudinal dimension of the first arm and a longitudinal dimension of the second arm are oriented in a longitudinal plane of the body, and in respective directions that are within 30 degrees of one another, and the first arm, second arm, and base portion define an elongated space extending from the base portion and between the first arm and the second arm.

2. The animal chew of claim 1, wherein the body consists of an edible animal chew composition.

3. The animal chew of claim 1, wherein the body defines a handle extending from the base portion or ii) one or more features configured to engage with a connectable handle.

4. (canceled)

5. The animal chew of claim 1, wherein the first and/or second arm(s) has/have a geometry that is symmetric about the longitudinal plane, and the first and second arms are symmetric.

6. The animal chew of claim 1, wherein the first and second arms define first and second indentations, each indentation recessing inward in an upper surface of their respective arm in a direction normal to the longitudinal plane, proximate an intersection of the arm and the base line and the bottom of each indentation comprises a layer of the edible animal chew composition less than 0.25 inches thick.

7. (canceled)

8. The animal chew of claim 1, wherein the first arm and the second arm flare apart from one another at the distal ends thereof.

9. The animal chew of claim 1, wherein the base portion, first arm, and second arm form a three dimensional U-shaped geometry.

10. The animal chew of claim 1, wherein the base portion, the first arm, and the second arm define:
an upper outer flange extending along an outer edge of the base portion, the first arm, and the second arm, in a direction normal to the longitudinal plane; and
a lower outer flange extending along the outer edge of the base portion, the first arm, and the second arm, in a direction opposite of the upper outer flange.

11. The animal chew of claim 1, wherein the base portion, the first arm, and the second arm define:
an upper inner flange extending along an inner edge of the base portion, the first arm, and the second arm, and projecting in a direction normal to the longitudinal plane; and
a lower inner flange extending along the inner edge of the base portion, the first arm, and the second arm, and projecting in a direction opposite of the upper inner flange.

12. The animal chew of claim 1, wherein the first arm and the second arm define:
a plurality of upper transverse flanges, spaced apart from one another, extending transversely across the first arm and the second arm, and projecting in a direction normal to the longitudinal plane; and
a plurality of lower transverse flanges, spaced apart from one another, extending transversely across the first arm and the second arm, and projecting in a direction of the upper transverse flanges.

13. (canceled)

14. The animal chew of claim 1, wherein the body defines a crosspiece extending in the longitudinal plane, from the first arm to the second arm.

15. The animal chew of claim 1, comprising a first outer layer and a second outer layer disposed in a plane in parallel with the longitudinal plane; and
an inner layer having different texture disposed between the first outer layer and the second outer layer.

16. The animal chew of claim 15, wherein the outer layers are solid and the inner layer is lattice or wherein the inner layer is solid and the outer layers are lattice.

17. (canceled)

18. The animal chew of claim 3, wherein the one or more features include:
a stem having a main body and one or more tabs projecting from opposite longitudinal sides of the main body proximate a distal end thereof, wherein the distal end of the main body has a cross-sectional geometry to fit within an aperture of a corresponding handle, wherein when the stem is fully inserted into the aperture of the handle the one or more tabs bear against an opposing surface of the handle to resist extraction of the stem from the aperture, thereby connecting the animal chew and the handle.

19. The animal chew of claim 1, comprising a dome, hemisphere or sphere positioned in the elongated space so that the diameter of the sphere, dome or hemisphere is within the longitudinal plane, and the circumference of the dome, hemisphere or sphere abuts an inner surface of the base portion, and first and second arms.

20. The animal chew of claim 19, wherein the dome, hemisphere or sphere comprises a flange about its circumference, the flange being positioned in the longitudinal plane and connected the dome, hemisphere or sphere to the base portion, and first and second arms.

21. The animal chew of claim 19, wherein the diameter of the dome, hemisphere or sphere is in the range of 0.25 to 2.5 inches.

22. The animal chew of claim 20, wherein the flange extends outward from the dome, hemisphere or sphere a distance in the range of 0.1 to 0.5 inches,

23. (canceled)

24. The animal chew of claim 22, wherein the flange extends around the entire circumference of the intersection of the domed surface and the longitudinal plane.

25. The animal chew of claim 20, wherein the flange defines:
a first surface having a first unitary flat portion extending around at least half of the circumference of the domed surface, and a first one or more features defined in the first unitary flat portion; and
a second surface superposed with and reverse of the first surface, the second surface having a second unitary flat portion extending around at least half of the circumference of the domed surface, and a second one or more features defined in the second unitary flat portion.

26-31. (canceled)
